(19) United States
(12) Patent Application Publication
(10) Pub. No.: US 2022/0229433 A1
(43) Pub. Date: Jul. 21, 2022

(54) MANEUVERING SUPPORT APPARATUS, MANEUVERING SUPPORT METHOD, AND COMPUTER-READABLE RECORDING MEDIUM

(71) Applicant: NEC Solution Innovators, Ltd., Koto-ku, Tokyo (JP)

(72) Inventor: Katsushi SHIMODOI, Tokyo (JP)

(21) Appl. No.: 17/618,253

(22) PCT Filed: Jun. 4, 2020
(86) PCT No.: PCT/JP2020/022067

§ 371 Date: Dec. 10, 2021

(30) Foreign Application Priority Data
Jun. 18, 2019 (JP) 2019-112716

(51) Int. Cl. G05D 1/00; B64C 39/02; B64D 47/08; G05D 1/10

(52) U.S. Cl. CPC G05D 1/0038; B64C 39/024; B64D 47/08; B64C 2201/146; G05D 1/0016; B64C 2201/027; B64C 2201/127; G05D 1/101

(57) ABSTRACT

A maneuvering support apparatus 10 comprises a flight control unit 11 that causes a second unmanned aerial vehicle having an imaging device to fly so as to follow a first unmanned aerial vehicle maneuvered by a pilot, and further, and controls the second unmanned aerial vehicle so that the first unmanned aerial vehicle is captured by the imaging device, an image display unit 12 that acquires an image data of an image captured by the imaging device, and displays the image based on the acquired image data on a screen of a display device.

### TECHNICAL FIELD

The present invention relates to a maneuvering support apparatus and a maneuvering support method for supporting a maneuvering of an unmanned aerial vehicle, and further relates to a computer-readable recording medium having recorded thereon a program for realizing the apparatus and method.

### BACKGROUND ART

Conventionally, an unmanned aerial vehicle called “drone” (hereinafter, “UAV (Unmanned Aerial Vehicle)” is used for various applications such as military use, pesticide spraying, cargo transportation, and area monitoring. Particularly, in recent years, small unmanned aerial vehicles that use an electric motor as a power source have been developed due to the miniaturization and high output of batteries. Small unmanned aerial vehicles are rapidly gaining in popularity due to their ease of operation.

Furthermore, UAV flights are carried out by autopilot or manual maneuvering. In the autopilot, UAV itself flies independently on the designated route while detecting its own location by GPS (Global positioning System) receiver mounted on itself. On the other hand, in manual maneuvering, UAV flies in response to operations performed by the pilot via the transmitter.

By the way, in the case of manual maneuvering, the pilot usually controls the UAV visually. If the UAV (drone) is located far away, it will be difficult for the pilot to see the UAV, and as a result, the pilot will not know a direction of a nose of the UAV, which can lead to maneuvering mistakes. In addition, a maneuvering mistake may cause a crash or the like. On the other hand, according to the autopilot, such a problem does not occur, but since the autopilot can only fly on a predetermined route, the use of the UAV is limited.

On the other hand, a maneuver called FPV (First Person View) flight is known (see, for example, Patent Document 1). FPV flight is a method in which a pilot controls a UAV while watching an image from a camera mounted on the UAV. In FPV flight, the pilot can control the UAV as if he were on the UAV, so even if the he cannot see the UAV, a possibility of a maneuvering mistake is low.

### LIST OF RELATED ART DOCUMENTS

### Patent Document

[Patent Document 1] JP2016-199261

### SUMMARY OF INVENTION

### Problems to be Solved by the Invention

However, in FPV flight, the pilot's field of view is limited to an angle of view of the camera mounted on the UAV. Therefore, there is a problem that it is very difficult for the pilot to check a situation around the UAV as compared with the case of visual flight. As a result, a probability of a crash in FPV flight is much higher than that in visual flight.

An example object of the present invention is to solve the aforementioned problems and to provide a maneuvering support apparatus, a maneuvering support method, and a computer-readable recording medium in which it possible to easily check a situation around the unmanned aerial vehicle while suppressing an occurrence of maneuvering mistakes in a case where it is difficult for the pilot to see the unmanned aerial vehicle.

### Means for Solving the Problems

In order to achieve the aforementioned object, a maneuvering support apparatus according to an example aspect of the present invention includes:

a flight control unit configured to cause a second unmanned aerial vehicle having an imaging device to fly so as to follow a first unmanned aerial vehicle maneuvered by a pilot, and further, and to control the second unmanned aerial vehicle so that the first unmanned aerial vehicle is captured by the imaging device; and

an image display unit configured to acquire an image data of an image captured by the imaging device, and to display the image based on the acquired image data on a screen of a display device.

Also, in order to achieve the aforementioned object, a maneuvering support method according to an example aspect of the present invention includes:

(a) a step of causing a second unmanned aerial vehicle having an imaging device to fly so as to follow a first unmanned aerial vehicle maneuvered by a pilot, and further, controlling the second unmanned aerial vehicle so that the first unmanned aerial vehicle is captured by the imaging device; and

(b) a step of acquiring an image data of an image captured by the imaging device, and displaying the image based on the acquired image data on a screen of a display device.

Further, in order to achieve the aforementioned object, a computer readable recording medium according to an example aspect of the present invention that includes a program recorded thereon, the program including instructions that cause a computer to carry out:

(a) a step of causing a second unmanned aerial vehicle having an imaging device to fly so as to follow a first unmanned aerial vehicle maneuvered by a pilot, and further, controlling the second unmanned aerial vehicle so that the first unmanned aerial vehicle is captured by the imaging device; and

(b) a step of acquiring an image data of an image captured by the imaging device, and displaying the image based on the acquired image data on a screen of a display device.

### Advantageous Effects of the Invention

As described above, according to the present invention, it is possible to easily check a situation around the unmanned aerial vehicle while suppressing an occurrence of maneuvering mistakes in a case where it is difficult for the pilot to see the unmanned aerial vehicle.

### BRIEF DESCRIPTION OF THE DRAWINGS

FIG. 1 is a block diagram illustrating a schematic configuration of a maneuvering support apparatus according to an example embodiment.

FIG. 2 is a block diagram illustrating a specific configuration of the maneuvering support apparatus according to the example embodiment.

FIG. 3 is a diagram illustrating an example of flight control of a second unmanned aerial vehicle performed in the example embodiment.

FIG. 4 is a diagram illustrating another example of flight control of the second unmanned aerial vehicle performed in the example embodiment.

FIG. 5 is a diagram illustrating a function assigned to a control stick when the second unmanned aerial vehicle is located above a unmanned aerial vehicle.

FIG. 6 is a diagram illustrating a function assigned to the control stick when the second unmanned aerial vehicle is located on the side of the first unmanned aerial vehicle.

FIG. 7 is a diagram illustrating a function assigned to the control stick when the second unmanned aerial vehicle is located behind the first unmanned aerial vehicle.

FIG. 8 is a flow diagram illustrating operations of the maneuvering support apparatus according to the example embodiment.

FIG. 9 is a block diagram illustrating an example of a computer that realizes the maneuvering support apparatus according to the example embodiment.

### EXAMPLE EMBODIMENT

### Example Embodiment

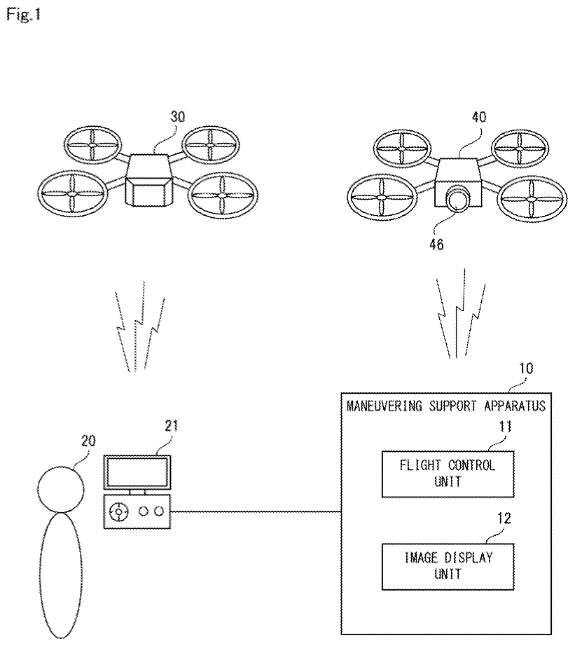

The following describes a maneuvering support apparatus, a maneuvering support method, and a program according to an example embodiment with reference to FIG. 1 to FIG. 9.

[Apparatus Configuration]

First, a schematic configuration of the maneuvering support apparatus according to the example embodiment will be described. FIG. 1 is a block diagram illustrating a schematic configuration of the maneuvering support apparatus according to the example embodiment.

A maneuvering support apparatus 10 shown in FIG. 1 is an apparatus for assisting a maneuvering of the first unmanned aerial vehicle 30 by a pilot 20. In FIG. 1, reference numeral 21 denotes a transmitter for maneuvering. As shown in FIG. 1, the maneuvering support apparatus 10 includes a flight control unit 11 and an image display unit 12.

The flight control unit 11 causes a second unmanned aerial vehicle 40 having an imaging device 46 to fly so as to follow a first unmanned aerial vehicle 30 maneuvered by the pilot 20. Further, the flight control unit 11 controls the second unmanned aerial vehicle 40 so that the first unmanned aerial vehicle 30 is captured by the imaging device. The image display unit 12 acquires an image data of an image captured by the imaging device, and displays an image based on the acquired image data on a screen of a display device.

In this way, by using the maneuvering support apparatus 10, the pilot 20 can check a situation around the first unmanned aerial vehicle 30 controlled by the pilot through the image from another following second unmanned aerial vehicle 40. Therefore, according to the example embodiment, in a case where it is difficult for the pilot 20 to see the first unmanned aerial vehicle 30, it is easy to check the situation around the first unmanned aerial vehicle 30 while suppressing an occurrence of maneuvering mistakes.

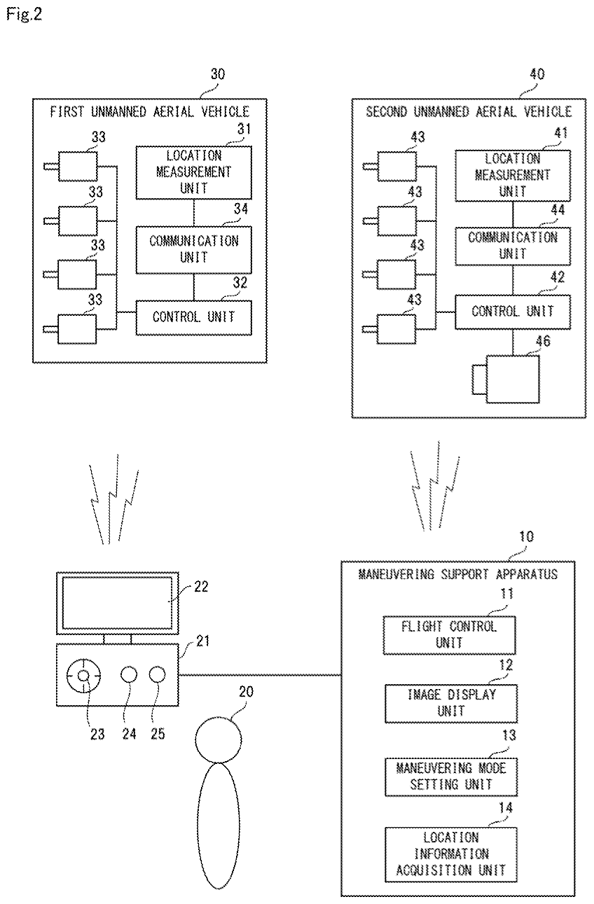

Subsequently, with reference to FIG. 2, the configuration and function of the maneuvering support apparatus 10 in the example embodiment will be explained in detail. FIG. 2 is a block diagram illustrating the specific configuration of the maneuvering support apparatus according to the example embodiment. In FIG. 2, the configurations of the unmanned aerial vehicles 30 and 40 are also shown by block diagrams.

As shown in FIG. 2, the first unmanned aerial vehicle 30 includes a location measurement unit 31, a control unit 32, drive motors 33, and a communication unit 34, and the control unit 32. Further, as shown in FIG. 1, the first unmanned aerial vehicle 30 is a multi-copter including four propellers (not shown in FIG. 2) and four drive motors 33. The first unmanned aerial vehicle 30 performs forward, backward, ascending, descending, right-turning, left-turning, and hovering by adjusting output of each drive motors 33.

The location measurement unit 31 includes a GPS (Global positioning System) receiver, and measures a location (latitude, longitude, altitude) of the first unmanned aerial vehicle 30 by using the GPS signal received by the GPS receiver. The location measurement unit 31 can also measure the altitude of the first unmanned aerial vehicle 30 by using, for example, a barometric pressure sensor. Further, the location measurement unit 31 outputs a location information (first location information) for specifying the measured location of the first unmanned aerial vehicle 30 to transmitter 21 for maneuvering the first unmanned aerial vehicle 30 via the communication unit 34.

The drive motor 33 drives the propeller of the first unmanned aerial vehicle 30. The communication unit 34 communicates with the transmitter 21 of the pilot 20, and receives a maneuvering instruction from the pilot 20 via the transmitter 21. In addition, the communication unit 34 receives the above-mentioned first location information from the first unmanned aerial vehicle 30.

The control unit 32 adjusts an output of each drive motor 33 based on the maneuvering instruction from the pilot 20, and controls the flight of the first unmanned aerial vehicle 30. Under the control of the control unit 32, the first unmanned aerial vehicle 30 performs forward, backward, ascending, descending, right-turning, left-turning, and hovering.

In addition, the transmitter 21 for maneuvering the first unmanned aerial vehicle 30 includes a display device 22, a control stick 23, a first button 24, and a second button 25. The image display unit 12 of the maneuvering support apparatus 10 displays the above-mentioned image on the screen of the display device 22.

As shown in FIG. 2, also the second unmanned aerial vehicle 40 includes a location measurement unit 41, a control unit 42, drive motors 43, and a communication unit 44. The second unmanned aerial vehicle 40 further includes imaging devise 45. Further, as shown in FIG. 1, the second unmanned aerial vehicle 40 is also a multi-copter including four propellers (not shown in FIG. 2) and four drive motors 33.The second unmanned aerial vehicle 40 performs forward, backward, ascending, descending, right-turning, left-turning, and hovering by adjusting output of each drive motors 43.

The location measurement unit 41 is configured as same as the location measurement unit 31 described above and includes a GPS (Global positioning System) receiver, and measures a location (latitude, longitude, altitude) of the second unmanned aerial vehicle 40. Further, the location measurement unit 41 outputs a location information (second location information) for specifying the measured location of the second unmanned aerial vehicle 40 to the maneuvering support apparatus 10. The drive motor 43 is also configured as same as the drive motor 33 described above and drives the propeller of the second unmanned aerial vehicle 40.

The communication unit 44 is different form the communication unit 34. The communication unit 44 communicates with the maneuvering support apparatus 10 and receives a maneuvering instruction from the maneuvering support apparatus 10. The control unit 42 adjusts an output of each drive motor 43 based on the maneuvering instruction from the maneuvering support apparatus 10, and controls the flight of the second unmanned aerial vehicle 40. Under the control of the control unit 42, the second unmanned aerial vehicle 40 performs forward, backward, ascending, descending, right-turning, left-turning, and hovering.

The image device 45 is a digital camera, captures an image at a set frame rate, and outputs an image data of the taken image to the communication unit 44. As a result, the communication unit 44 transmits the image data to the maneuvering support apparatus 10 at the set frame rate. Further, the image device 45 is provided with a function of freely setting a shooting direction in response to an instruction from the maneuvering support apparatus 10. For example, when the second unmanned aerial vehicle 40 is located directly above the first unmanned aerial vehicle 30, the image device 45 sets the shooting direction downward. When the second unmanned aerial vehicle 40 is located directly behind the first unmanned aerial vehicle 30, the imaging device 45 sets the capturing direction as forward.

Further, as shown in FIG. 2, the maneuvering support apparatus 10 includes a maneuvering mode setting unit 13 and a location information acquisition unit 14 in addition to the flight control unit 11 and the image display unit 12 described above. Further, the maneuvering support apparatus 10 is connected to the transmitter 21 of the first unmanned aerial vehicle.

The maneuvering mode setting unit 13 sets the maneuvering mode of the transmitter 21 of the first unmanned aerial vehicle 30, that is, the function assigned to the control stick 23, the first button 24, and the second button 25. Specifically, the maneuvering mode setting unit 13 sets the function assigned to the control stick 23, the first button 24, and the second button 25 based on the nose direction of the first unmanned aerial vehicle 30 displayed on the screen of the display device 22.

The location information acquisition unit 14 acquires the above-mentioned first location information via the transmitter 21, and further acquires the second location information from the second unmanned aerial vehicle 40. In the example embodiment, the flight control unit 11 controls the second unmanned aerial vehicle 40 based on the acquired first location information and the acquired second location information.

Further, the flight control unit 11, causes the second unmanned aerial vehicle 40 to follow the first unmanned aerial vehicle 30 so that the second unmanned aerial vehicle 40 is located above, on the side of, or behind the first unmanned aerial vehicle 30, based on the first location information and the second location information.

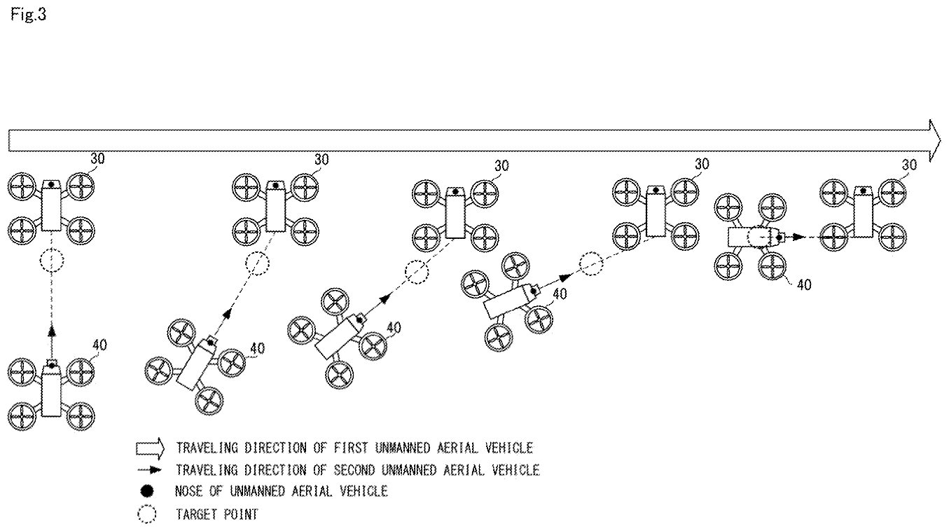

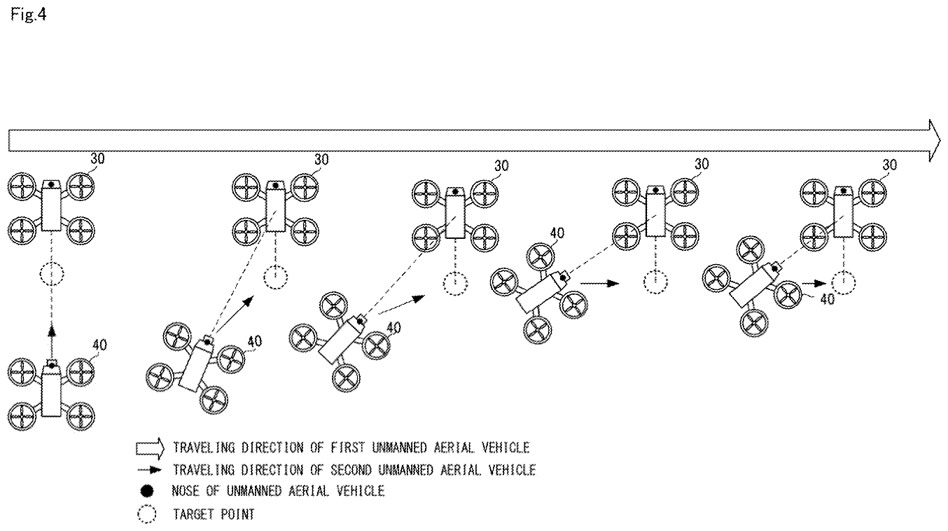

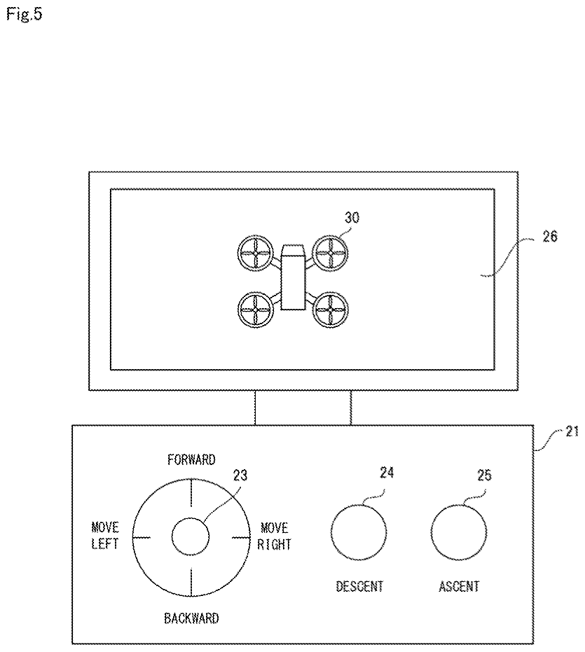

Specifically, the flight control unit 11 first causes the second unmanned aerial vehicle 40 to reach a target point set in advance near the first unmanned aerial vehicle 30 (see FIGS. 3 and 4). Next, when the second unmanned aerial vehicle 40 reaches the target point, the flight control unit 11 causes the second unmanned aerial vehicle 40 to follow the first unmanned aerial vehicle 30. Then, when the follow-up is started, the maneuvering mode setting unit 13 sets the maneuvering mode as described above (see FIGS. 5 to 7).

Subsequently, with reference to FIGS. 3 and 4, flight control performed by the flight control unit 11 until the second unmanned aerial vehicle 40 reaches a target point will be described. FIG. 3 is a diagram illustrating an example of flight control of the second unmanned aerial vehicle performed in the example embodiment. FIG. 4 is a diagram illustrating another example of flight control of the second unmanned aerial vehicle performed in the example embodiment.

In the example of FIG. 3, the flight control unit 11 sets the target point between the first unmanned aerial vehicle 30 and the second unmanned aerial vehicle 40 based on the first location information and the second location information. Then, the flight control unit 11 instructs a speed, a traveling direction, and an altitude of the second unmanned aerial vehicle 40 so that the second unmanned aerial reaches the target point. At this time, the flight control unit 11 also instructs the second unmanned aerial vehicle 40 so that a nose and the traveling direction of the second unmanned aerial vehicle 40 face the target point.

When the flight control shown in FIG. 3 is performed, the traveling nose of the second unmanned aerial vehicle 40 become the target point, and the first unmanned aerial vehicle 30 exists as an extension of the target point. Therefore, the first unmanned aerial vehicle 30 inevitably fits in an angle of view of the imaging device 46 of the second unmanned aerial vehicle 40.

That is, in the example of FIG. 3, the first unmanned aerial vehicle 30 naturally fits within the angle of view of the imaging device with simple control without using information about the nose direction of the first unmanned aerial vehicle 30. Since the target point is set on a straight line connecting the first unmanned aerial vehicle 30 and the second unmanned aerial vehicle 40, it is possible to shorten a time required for the second unmanned aerial vehicle 40 to reach the target point. Further, due to these features, the flight control shown in FIG. 3 is useful for a purpose of recording an image.

In the example of FIG. 4, the flight control units 11 sets the target point at a location at a certain distance from a rear side of a fuselage of the first unmanned aerial vehicle 30 based on the first location information. Then, the flight control unit 11 controls the speed, the traveling direction, and the altitude of the second unmanned aerial vehicle 40 so that the second unmanned aerial vehicle 40 reaches the target point. However, in the example of FIG. 4, the flight control unit 11 controls the second unmanned aerial vehicle 40 points so that the nose of the second unmanned aerial vehicle 40 faces to the first unmanned aerial vehicle 30, and the traveling direction of the second unmanned aerial vehicle 40 faces to the target point.

In the example of FIG. 4, unlike the example of FIG. 4, the flight control unit 11 needs to control the nose direction of the second unmanned aerial vehicle 40, control process become complicated. However, according to the example of FIG. 4, it is possible to reduce a possibility that the first unmanned aerial vehicle 30 deviates from the angle of view of the image device 45 as compared with the example of FIG. 3. Further, after the second unmanned aerial vehicle 40 reaches the target point, the nose direction of the second unmanned aerial vehicle 40 matches the nose direction of the first unmanned aerial vehicle 30. This always provides the pilot with optimal maneuvering support.

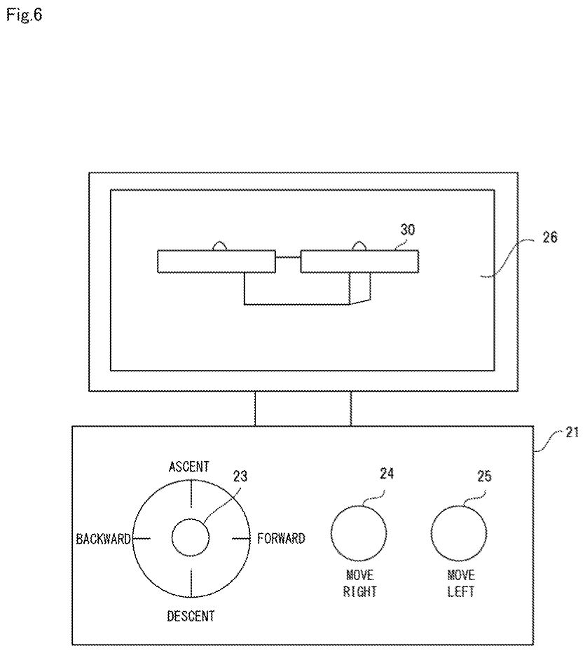

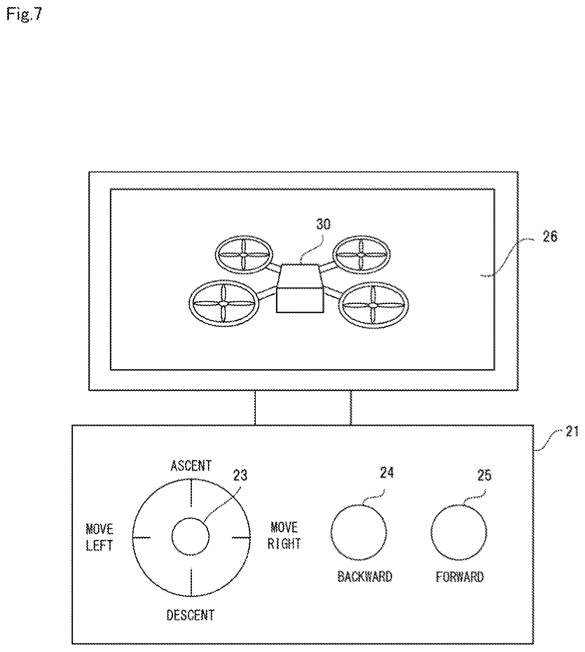

Subsequently, a setting of the transmitter 21 in a case of following flight will be described in detail with reference to FIGS. 5 to 7. FIG. 5 is a diagram illustrating a function assigned to the control stick when the second unmanned aerial vehicle is located above the first unmanned aerial vehicle. FIG. 6 is a diagram illustrating a function assigned to the control stick when the second unmanned aerial vehicle is located on the side of the first unmanned aerial vehicle. FIG. 7 is a diagram illustrating a function assigned to the control stick when the second unmanned aerial vehicle is located behind the first unmanned aerial vehicle.

In the example of FIG. 5, the second unmanned aerial vehicle 40 is located above the first unmanned aerial vehicle 30. In this case, as shown in FIG. 5, a upper surface of the first unmanned aerial vehicle 30 is displayed on the screen of the display device 22 of the transmitter 21. In the example of FIG. 5, a upper side of the screen is aligned with a nose side of the first unmanned aerial vehicle 30.

Therefore, the maneuvering mode setting unit 13 assigns front and back of the control stick 23 of the control stick 23 to the forward and backward movements, and assigns the left and right of the control stick 23 to the left movement and right movement. Further, the maneuvering mode setting unit 13 assigns the first button 24 to descending and the second button 25 to ascending.

In the example of FIG. 6, the second unmanned aerial vehicle 40 is located on the right side of the first unmanned aerial vehicle 30. In this case, as shown in FIG. 6, the right-side surface of the first unmanned aerial vehicle 30 is displayed on the screen of the display device 22 of the transmitter 21. In the example of FIG. 5, the right side of the screen is aligned with the nose side of the first unmanned aerial vehicle 30.

Therefore, the maneuvering mode setting unit 13 assigns front and back of the control stick 23 of the control stick 23 to the ascending and descending, and assigns the left and right of the control stick 23 to forward and backward movements. Further, the maneuvering mode setting unit 13 assigns the first button 24 to moving to the front side (right movement) and the second button 25 to moving to the back side (left movement).

In the example of FIG. 7, the second unmanned aerial vehicle 40 is located behind the first unmanned aerial vehicle 30. In this case, as shown in FIG. 7, a rear surface of the first unmanned aerial vehicle 30 is displayed on the screen of the display device 22 of the transmitter 21. In the example of FIG. 7, a back side of the screen is aligned with the nose side of the first unmanned aerial vehicle 30.

Therefore, the maneuvering mode setting unit 13 assigns the front and back of the control stick 23 of the control stick 23 to the ascending and descending, and assigns the left and right of the control stick 23 to the left movement and right movement. Further, the maneuvering mode setting unit 13 assigns the first button 24 to the backward and the second button 25 to the forward.

As shown in FIGS. 5 to 7, in the example embodiment, functions are assigned to the control stick 23, the first button 24, and the second button 25 of the transmitter 21 according to a state of the first unmanned aerial vehicle 30 displayed on the screen. Therefore, the pilot can intuitively maneuver while looking at the screen, and the occurrence of maneuvering mistakes is suppressed.

[Apparatus Operations]

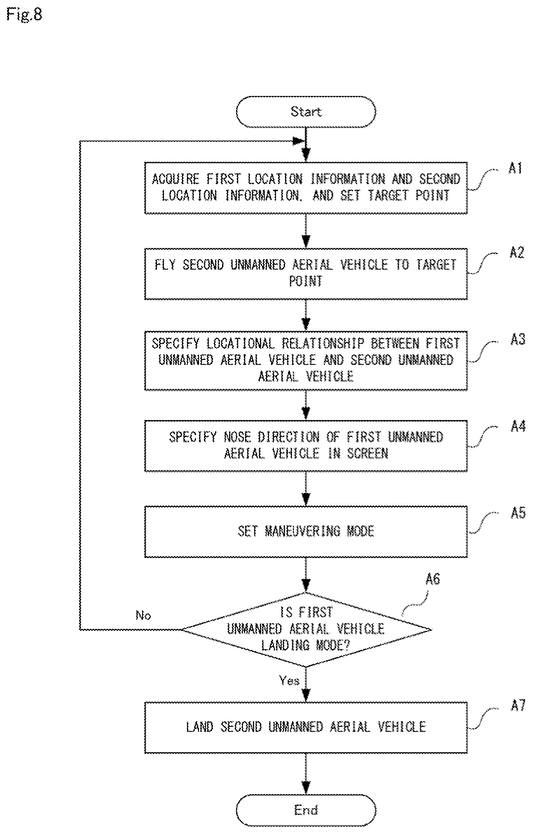

Next, an operation of the maneuvering support apparatus 10 according to the example embodiment will be described with reference to FIG. 8. FIG. 8 is a flow diagram illustrating the operation of the maneuvering support apparatus according to the example embodiment. In the following description, FIGS. 1 to 7 will be referred to as appropriate. Furthermore, in the example embodiment, the maneuvering support method is implemented by operating the maneuvering support apparatus 10. Therefore, a description of the maneuvering support method in the example embodiment will be replaced with the following description of the operation of the maneuvering support apparatus 10.

As shown in FIG. 8, first, the flight control unit 11 sets the target point for the second unmanned aerial vehicle 40 to follow the first unmanned aerial vehicle 40, based on the first location information of the first unmanned aerial vehicle 30 and the second location information of the second unmanned aerial vehicle 40 (step A1).

Next, the flight control unit 11 causes the second unmanned aerial vehicle 40 to fly to the target point set in step A1 (step A2). Specifically, as shown in FIG. 3 or 4, the flight control unit 11 instructs the speed, the traveling direction, and the altitude of the second unmanned aerial vehicle 40 so that ii reaches the target point.

Further, during the execution of step A2, the image data captured by the image device 45 is transmitted from the second unmanned aerial vehicle 40 at a predetermined frame rate. Therefore, the image display unit 12 sends an image of the transmitted image data to the transmitter 21 and cause the display device 22 to displays the image on the screen.

Next, the maneuvering mode setting unit 13 specifies a locational relationship between the first unmanned aerial vehicle 30 and the second unmanned aerial vehicle 40 based on the latest first location information and the second location information (step A3). Specifically, in step A3, the maneuvering mode setting unit 13 determines whether the second unmanned aerial vehicle 40 is located above, on the side of, or behind the first unmanned aerial vehicle 30.

Next, the maneuvering mode setting unit 13 specifies the nose direction of the first unmanned aerial vehicle 30 displayed on the screen of the display device 22 (step A4).

Specifically, since a feature value indicating the nose is registered in advance, the maneuvering mode setting unit 13 specifies an area where the registered feature value is detected from the image transmitted by the image display unit 12, and specified the nose direction based on a location of the specified area. For example, when the registered feature value is detected from an area on the right side of the screen, the maneuvering mode setting unit 13 specifies a direction toward a right side of the screen as the nose direction.

When the first unmanned aerial vehicle 30 is provided with an electronic compass for measuring the nose direction, the maneuvering mode setting unit 13 acquires a measurement result by the electronic compass ,and can specify the nose direction of the first unmanned aerial vehicle 30 based on the acquired measurement result.

Next, the maneuvering mode setting unit 13 sets the maneuvering mode of the transmitter of the first unmanned aerial vehicle 30 based on the locational relationship specified in step A3 and the locational relationship specified in step A4 (step A5).

For example, in step A3, it is specified that the second unmanned aerial vehicle 40 is located above the first unmanned aerial vehicle 30 as a locational relationship, and in step A4, the nose direction is specified on the upper side of the screen as a locational relationship. In this case, the maneuvering mode setting unit 13 assigns functions to the control stick 23, the first button 24, and the second button 25, as shown in FIG.5.

After executing step A5, the flight control unit 11 determines whether or not the first unmanned aerial vehicle 30 has entered a landing mode (step A6). Specifically, the flight control unit 11 determines whether or not the pilot has instructed the first unmanned aerial vehicle 30 to land via the transmitter 21.

As a result of the determination in step A6, if the first unmanned aerial vehicle has not entered the landing mode, the flight control unit 11 executes step A1 again. On the other hand, as a result of the determination in step A6, when the first unmanned aerial vehicle has entered to the landing mode, the flight control unit 11 lands the second unmanned aerial vehicle 40 and ends the process (step A7).

[Effects in the Example Embodiment]

As described above, in the example embodiment, the pilot 20 can check the situation around the first unmanned aerial vehicle 30 that the pilot controls by the image from another following second unmanned aerial vehicle 40. Further, since the maneuvering mode of the transmitter 21 is set according to a state displayed on the image, the pilot 20 can intuitively maneuver the first unmanned aerial vehicle 30. Therefore, according to the example embodiment, in a case where it is difficult for the pilot 20 to see the first unmanned aerial vehicle 30, it is easy to check the situation around the first unmanned aerial vehicle 30 while suppressing the occurrence of maneuvering mistakes.

Further, in the example embodiment, since it is possible to capture the first unmanned aerial vehicle 30 from a bird's-eye view, it is possible to record an image from a bird's-eye view. Such records are useful for confirming work, analyzing accidents, and the like.

[Program]

It is sufficient that the program according to the present example embodiment to be a program that causes a computer to execute steps A1 to A7 illustrated in FIG. 8. The maneuvering support apparatus 10 and the maneuvering support method according to the present example embodiment can be realized by installing this program in the computer and executing this program.

In this case, a processor of the computer functions as the flight control unit 11, the image display unit 12, the maneuvering mode setting unit 13 and the location information acquisition unit 14, and performs processing.

Moreover, the program according to the present example embodiment may be executed by a computer system constructed with a plurality of computers. In this case, for example, each computer may function as one of the flight control unit 11, the image display unit 12, the maneuvering mode setting unit 13 and the location information acquisition unit 14.

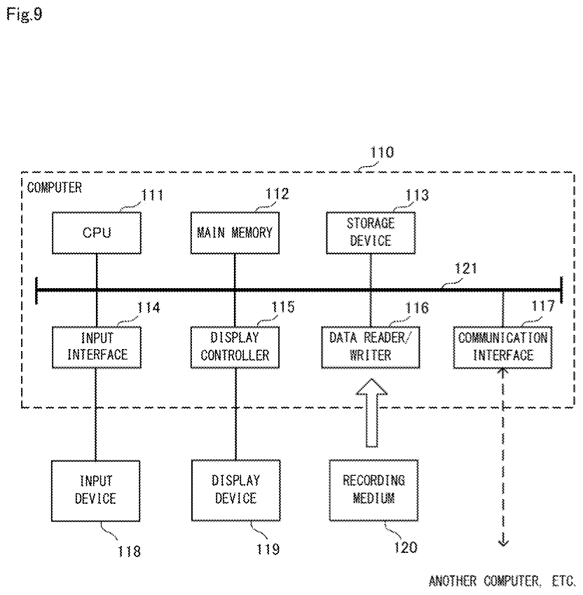

Using FIG.9, the following describe a computer that realizes the maneuvering support apparatus 10 by executing the program according to the present example embodiment. FIG. 9 is a block diagram illustrating one example of the computer that realizes the maneuvering support apparatus according to the example embodiment.

As shown in FIG. 9, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121. Note that the computer 110 may include a GPU (Graphics Processing Unit) or an FPGA (Field-Programmable Gate Array) in addition to the CPU 111 or in place of the CPU 111.

The CPU 111 carries out various types of calculation by deploying the program (codes) according to the example embodiment stored in the storage device 113 to the main memory 112, and executing the codes in a predetermined order. The main memory 112 is typically a volatile storage device, such as a DRAM (Dynamic Random Access Memory). Also, the program according to the example embodiment is provided in a state where it is stored in a computer readable recording medium 120. Note that the program according to the example embodiment may also be distributed over the Internet connected via the communication interface 117.

Furthermore, specific examples of the storage device 113 include a hard disk drive, and also a semiconductor storage device, such as a flash memory. The input interface 114 mediates data transmission between the CPU 111 and an input device 118, such as a keyboard and a mouse. The display controller 115 is connected to a display device 119, and controls displays on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Also, specific examples of the recording medium 120 include: a general-purpose semiconductor storage device, such as CF (Compact Flash®) and SD (Secure Digital); a magnetic recording medium, such as Flexible Disk; and an optical recording medium, such as CD-ROM (Compact Disk Read Only Memory).

Note that the maneuvering support apparatus 10 according to the example embodiment can also be realized by using items of hardware that respectively correspond to the components, rather than the computer in which the program is installed. Furthermore, a part of the maneuvering support apparatus 10 may be realized by the program, and the remaining part of the maneuvering support apparatus 10 may be realized by hardware.

A part or all of the aforementioned example embodiment can be represented by (Supplementary Note 1) to (Supplementary Note 21) described below, but is not limited to the description below.

(Supplementary Note 1)

A maneuvering support apparatus comprising:

a flight control unit configured to cause a second unmanned aerial vehicle having an imaging device to fly so as to follow a first unmanned aerial vehicle maneuvered by a pilot, and further, control the second unmanned aerial vehicle so that the first unmanned aerial vehicle is captured by the imaging device; and

an image display unit configured to acquire an image data of an image captured by the imaging device, and displaying the image based on the acquired image data on a screen of a display device.

(Supplementary Note 2)

The maneuvering support apparatus according to Supplementary Note 1 further comprising:

a maneuvering mode setting unit configured to set a maneuvering mode of a transmitter of the first unmanned aerial vehicle.

(Supplementary Note 3)

The maneuvering support apparatus according to Supplementary Note 2, wherein

the maneuvering mode setting unit sets the maneuvering mode based on a nose direction of the first unmanned aerial vehicle displayed on the screen.

(Supplementary Note 4)

The maneuvering support apparatus according to any one of Supplementary Notes 1 to 3 further comprising:

a location information acquisition unit configured to acquire a first location information for specifying a location of the first unmanned aerial vehicle and a second location information for specifying a location of the second unmanned aerial vehicle; and

wherein, the flight control unit controls the second unmanned aerial vehicle based on the acquired first location information and the acquired second location information.

(Supplementary Note 5)
5. The maneuvering support apparatus according to claim 4, wherein

the flight control unit causes the second unmanned aerial vehicle to follow the first unmanned aerial vehicle so that the second unmanned aerial vehicle is located above, on the side of, or behind the first unmanned aerial vehicle, based on the first location information and the second location information.

(Supplementary Note 6)

The maneuvering support apparatus according to Supplementary Note 4 or 5, wherein

the flight control unit sets a target point between the first unmanned aerial vehicle and the second unmanned aerial vehicle based on the first location information and the second location information, and controls the second unmanned aerial vehicle so that a nose and a traveling direction of the second unmanned aerial vehicle point toward to the target point.

(Supplementary Note 7)

The maneuvering support apparatus according to Supplementary Note 4 or 5, wherein

the flight control unit sets a target point at a location at a certain distance from a rear side of a fuselage of the first unmanned aerial vehicle, and controls the second unmanned aerial vehicle so that a nose of the second unmanned aerial vehicle points toward to the first unmanned aerial vehicle and a traveling direction of the second unmanned aerial vehicle points toward to the target point.

(Supplementary Note 8)
8. A maneuvering support method comprising:

(a) a step of causing a second unmanned aerial vehicle having an imaging device to fly so as to follow a first unmanned aerial vehicle maneuvered by a pilot, and further, controlling the second unmanned aerial vehicle so that the first unmanned aerial vehicle is captured by the imaging device; and

(b) a step of acquiring an image data of an image captured by the imaging device, and displaying the image based on the acquired image data on a screen of a display device.

(Supplementary Note 9)

The maneuvering support method according to Supplementary Note 8 further comprising:

(c) a step of setting a maneuvering mode of a transmitter of the first unmanned aerial vehicle.

(Supplementary Note 10)

The maneuvering support method according to Supplementary Note 9, wherein,

in the (c) step, setting the maneuvering mode based on a nose direction of the first unmanned aerial vehicle displayed on the screen.

(Supplementary Note 11)

The maneuvering support method according to any one of Supplementary Notes 8 to 10, further comprising:

(d) a step of acquiring a first location information for specifying a location of the first unmanned aerial vehicle and a second location information for specifying a location of the second unmanned aerial vehicle; and

in the (a) step, controlling the second unmanned aerial vehicle based on the acquired first location information and the acquired second location information.

(Supplementary Note 12)

The maneuvering support method according to Supplementary Note 11, wherein

in the (a) step,

causing the second unmanned aerial vehicle to follow the first unmanned aerial vehicle so that the second unmanned aerial vehicle is located above, on the side of, or behind the first unmanned aerial vehicle, based on the first location information and the second location information.

(Supplementary Note 13)

The maneuvering support method according to Supplementary Note 11 or 12, wherein

in the (a) step,

setting a target point between the first unmanned aerial vehicle and the second unmanned aerial vehicle based on the first location information and the second location information; and

controlling the second unmanned aerial vehicle so that a nose and a traveling direction of the second unmanned aerial vehicle point toward to the target point.

(Supplementary Note 14)

The maneuvering support method according to Supplementary Note 11 or 12, wherein

in the (a) step,

setting a target point at a location at a certain distance from a rear side of a fuselage of the first unmanned aerial vehicle; and

controlling the second unmanned aerial vehicle so that a nose of the second unmanned aerial vehicle points toward to the first unmanned aerial vehicle and a traveling direction of the second unmanned aerial vehicle points toward to the target point.

(Supplementary Note 15)

A computer readable recording medium that includes a program recorded thereon, the program including instructions that cause a computer to carry out:

(a) a step of causing a second unmanned aerial vehicle having an imaging device to fly so as to follow a first unmanned aerial vehicle maneuvered by a pilot, and further, controlling the second unmanned aerial vehicle so that the first unmanned aerial vehicle is captured by the imaging device; and

(b) a step of acquiring an image data of an image captured by the imaging device, and displaying the image based on the acquired image data on a screen of a display device, and displaying the image based on the acquired image data on a display devise.

(Supplementary Note 16)

The computer readable recording medium according to Supplementary Note 15,

wherein the program further includes instructions that cause the computer to carry out:

(c) a step of setting a maneuvering mode of a transmitter of the first unmanned aerial vehicle.

(Supplementary Note 17)

The computer readable recording medium according to Supplementary Note 16, wherein

in the (c) step,

setting the maneuvering mode based on a nose direction of the first unmanned aerial vehicle displayed on the screen.

(Supplementary Note 18)

The computer readable recording medium according to any one of Supplementary Notes 15 to 17,

wherein the program further includes instructions that cause the computer to carry out:

(d) a step of acquiring a first location information for specifying a location of the first unmanned aerial vehicle and a second location information for specifying a location of the second unmanned aerial vehicle;

in the (a) step, controlling the second unmanned aerial vehicle based on the acquired first location information and the acquired second location information.

(Supplementary Note 19)

The computer readable recording medium according to Supplementary Note 18, wherein

in the (a) step,

causing the second unmanned aerial vehicle to follow the first unmanned aerial vehicle so that the second unmanned aerial vehicle is located above, on the side of, or behind the first unmanned aerial vehicle, based on the first location information and the second location information.

(Supplementary Note 20)

The computer readable recording medium according to Supplementary Note 18 or 19, wherein

in the (a) step,

setting a target point at a location at a certain distance from a rear side of a fuselage of the first unmanned aerial vehicle; and

controlling the second unmanned aerial vehicle so that a nose of the second unmanned aerial vehicle points toward to the first unmanned aerial vehicle and a traveling direction of the second unmanned aerial vehicle points toward to the target point.

(Supplementary Note 21)

The computer readable recording medium according to Supplementary Note 18 or 19, wherein

in the (a) step,

setting a target point at a location at a certain distance from a rear side of a fuselage of the first unmanned aerial vehicle; and

controlling the second unmanned aerial vehicle so that a nose of the second unmanned aerial vehicle points toward to the first unmanned aerial vehicle and a traveling direction of the second unmanned aerial vehicle points toward to the target point.

Although the invention of the present application has been described above with reference to the example embodiment, the invention of the present application is not limited to the aforementioned example embodiment. Various changes that can be understood by a person skilled in the art within the scope of the invention of the present application can be made to the configurations and details of the invention of the present application.

This application claims priority on the basis of Japanese application Japanese Patent Application No. 2019-12716 filed on Jun. 18, 2019, and the entire disclosure of which is incorporated herein.

### INDUSTRIAL APPLICABILITY

According to the present invention, it is possible to easily check the surrounding situation around the unmanned aerial vehicle while suppressing the occurrence of maneuvering mistakes in a case where it is difficult for the pilot to see the unmanned aerial vehicle. The present invention is useful in various fields where the use of unmanned aerial vehicles is required.

### REFERENCE SIGNS LIST

10 maneuvering support apparatus

11 flight control unit

12 image display unit

12 maneuvering mode setting unit

13 location information acquisition unit

20 pilot

21 transmitter

22 display devise

23 control stick

24 first button

25 second button

30 first unmanned aerial vehicle

31 location measurement unit

32 control unit

33 drive motor

34 communication unit

40 second unmanned aerial vehicle

41 location measurement unit

42 control unit

43 drive motor

44 communication unit

45 imaging device

110 computer

111 CPU

112 main memory

113 storage device

114 input interface

115 display controller

116 data reader/writer

117 communication interface

118 input devise

119 display devise

120 recording medium

121 bus

What is claimed is:

1. A maneuvering support apparatus comprising:
a flight control unit that causes a second unmanned aerial vehicle having an imaging device to fly so as to follow a first unmanned aerial vehicle maneuvered by a pilot, and further, controls the second unmanned aerial vehicle so that the first unmanned aerial vehicle is captured by the imaging device; and
an image display unit that acquires an image data of an image captured by the imaging device, and displays the image based on the acquired image data on a screen of a display device.

2. The maneuvering support apparatus according to claim 1 further comprising:
a maneuvering mode setting unit that sets a maneuvering mode of a transmitter of the first unmanned aerial vehicle.

3. The maneuvering support apparatus according to claim 2, wherein
the maneuvering mode setting unit sets the maneuvering mode based on a nose direction of the first unmanned aerial vehicle displayed on the screen.

4. The maneuvering support apparatus according to claim 1 further comprising:
a location information acquisition unit that acquires a first location information for specifying a location of the first unmanned aerial vehicle and a second location information for specifying a location of the second unmanned aerial vehicle; and
wherein, the flight control unit controls the second unmanned aerial vehicle based on the acquired first location information and the acquired second location information.

5. The maneuvering support apparatus according to claim 4, wherein
the flight control unit causes the second unmanned aerial vehicle to follow the first unmanned aerial vehicle so that the second unmanned aerial vehicle is located above, on the side of, or behind the first unmanned aerial vehicle, based on the first location information and the second location information.

6. The maneuvering support apparatus according to claim 4, wherein
the flight control unit sets a target point between the first unmanned aerial vehicle and the second unmanned aerial vehicle based on the first location information and the second location information, and controls the second unmanned aerial vehicle so that a nose and a traveling direction of the second unmanned aerial vehicle point toward to the target point.

7. The maneuvering support apparatus according to claim 4, wherein
the flight control unit sets a target point at a location at a certain distance from a rear side of a fuselage of the first unmanned aerial vehicle, and controls the second unmanned aerial vehicle so that a nose of the second unmanned aerial vehicle points toward to the first unmanned aerial vehicle and a traveling direction of the second unmanned aerial vehicle points toward to the target point.

8. A maneuvering support method comprising:
causing a second unmanned aerial vehicle having an imaging device to fly so as to follow a first unmanned aerial vehicle maneuvered by a pilot, and further, controlling the second unmanned aerial vehicle so that the first unmanned aerial vehicle is captured by the imaging device; and
acquiring an image data of an image captured by the imaging device, and displaying the image based on the acquired image data on a screen of a display device.

9. The maneuvering support method according to claim 8 further comprising:
setting a maneuvering mode of a transmitter of the first unmanned aerial vehicle.

10. The maneuvering support method according to claim 9, wherein,
in setting the maneuvering mode,
setting the maneuvering mode based on a nose direction of the first unmanned aerial vehicle displayed on the screen.

11. The maneuvering support method according to claim 8, further comprising:
acquiring a first location information for specifying a location of the first unmanned aerial vehicle and a second location information for specifying a location of the second unmanned aerial vehicle; and
in controlling the second unmanned aerial vehicle,
controlling the second unmanned aerial vehicle based on the acquired first location information and the acquired second location information.

12. The maneuvering support method according to claim 11, wherein
in controlling the second unmanned aerial vehicle,
causing the second unmanned aerial vehicle to follow the first unmanned aerial vehicle so that the second unmanned aerial vehicle is located above, on the side of, or behind the first unmanned aerial vehicle, based on the first location information and the second location information.

13. The maneuvering support method according to claim 11 wherein
in controlling the second unmanned aerial vehicle,
setting a target point between the first unmanned aerial vehicle and the second unmanned aerial vehicle based on the first location information and the second location information; and
controlling the second unmanned aerial vehicle so that a nose and a traveling direction of the second unmanned aerial vehicle point toward to the target point.

14. The maneuvering support method according to claim 11 wherein
in controlling the second unmanned aerial vehicle,
setting a target point at a location at a certain distance from a rear side of a fuselage of the first unmanned aerial vehicle; and
controlling the second unmanned aerial vehicle so that a nose of the second unmanned aerial vehicle points toward to the first unmanned aerial vehicle and a traveling direction of the second unmanned aerial vehicle points toward to the target point.

15. A non-transitory computer readable recording medium that includes a program recorded thereon, the program including instructions that cause a computer to carry out:
causing a second unmanned aerial vehicle having an imaging device to fly so as to follow a first unmanned aerial vehicle maneuvered by a pilot, and further, controlling the second unmanned aerial vehicle so that the first unmanned aerial vehicle is captured by the imaging device; and
acquiring an image data of an image captured by the imaging device, and displaying the image based on the acquired image data on a screen of a display device, and displaying the image based on the acquired image data on a display devise.

16. The non-transitory computer readable recording medium according to claim 15,
wherein the program further includes instructions that cause the computer to carry out:
setting a maneuvering mode of a transmitter of the first unmanned aerial vehicle.

17. The non-transitory computer readable recording medium according to claim 16, wherein,
in setting the maneuvering mode,
setting the maneuvering mode based on a nose direction of the first unmanned aerial vehicle displayed on the screen.

18. The non-transitory computer readable recording medium according to claim 15,
wherein the program further includes instructions that cause the computer to carry out:
acquiring a first location information for specifying a location of the first unmanned aerial vehicle and a second location information for specifying a location of the second unmanned aerial vehicle; and
in controlling the second unmanned aerial vehicle,
controlling the second unmanned aerial vehicle based on the acquired first location information and the acquired second location information.

19. The non-transitory computer readable recording medium according to claim 18, wherein
in controlling the second unmanned aerial vehicle,
causing the second unmanned aerial vehicle to follow the first unmanned aerial vehicle so that the second unmanned aerial vehicle is located above, on the side of, or behind the first unmanned aerial vehicle, based on the first location information and the second location information.

20. The non-transitory computer readable recording medium according to claim 18, wherein
in controlling the second unmanned aerial vehicle,
setting a target point at a location at a certain distance from a rear side of a fuselage of the first unmanned aerial vehicle; and
controlling the second unmanned aerial vehicle so that a nose of the second unmanned aerial vehicle points toward to the first unmanned aerial vehicle and a traveling direction of the second unmanned aerial vehicle points toward to the target point.

21. (canceled)
